(19) United States
(12) Patent Application Publication
(10) Pub. No.: US 2009/0299635 A1
(43) Pub. Date: Dec. 3, 2009

(54) Terrain mapping

(76) Inventors: Tom Meredydd Brookes, Devon (GB); Nicholas Robert Geoffrey Wilkinson, Devon (GB)

Correspondence Address: SCULLY, SCOTT, MURPHY & PRESSER, P.C., 400 GARDEN CITY PLAZA, SUITE 300, GARDEN CITY, NY, 11530, US

(21) Appl. No.: 11/659,652

(22) PCT Filed: Oct. 9, 2006
(86) PCT No.: PCT/GB2006/050321

§ 371 Date: Aug. 11, 2009

(30) Foreign Application Priority Data
Oct. 13, 2005 (EP) 05270067.1
Oct. 13, 2005 (GB) 0520738.6

(51) Int. Cl. G06F 19/00

(52) U.S. Cl. 702/5

(57) ABSTRACT

A terrain mapping apparatus (1) carried by an aircraft is arranged to receive height data from a terrain elevation data array memory (7), to determine the correlation between elements of the terrain elevation data array memory (7) and detected height data stored in elements of a laser obstacle detector co-ordinate frame memory (4). The height data of the laser obstacle detector co-ordinate frame memory being provided by a laser obstacle detector (3) monitoring terrain overflown by the aircraft.

Updated height data, determined by a mapping processor 5 for each element of the terrain elevation data array memory (7) is provided from height data associated with a predetermined number, typically four, surrounding elements of the laser obstacle detector co-ordinate frame memory (4) and updated height data is then stored in a digital elevation array memory (8).

The present invention relates to a method of terrain mapping and terrain mapping apparatus.

There is a growing demand for high resolution digital elevation data for use in fields as diverse as military targeting and building development. Traditionally, methods of obtaining digital elevation data rely on photogrametric surveys referenced using a high accuracy navigation system, for example a Global Positioning System. Gathering of digital elevation data by this method is both time-consuming and expensive. This has the result of terrain areas being infrequently mapped, if at all, providing, at best, patchy digital elevation data for a given region.

Laser based mapping systems have been developed to provide digital elevation data. Such systems rely on a combination of a ground based Global Positioning System, together with a combination of Global Positioning Systems and Inertial Navigation Systems carried by an aircraft, which flies over terrain to be mapped, to obtain a sufficient accuracy. However, without a ground station the accuracy that can be obtained even using Global Positioning System P code, is approximate to a 16 metres spherical volume. Accordingly, there is a need for a mapping system which provides an improved resolution than that provided by traditional methods without the requirement for a ground based Global Positioning System.

According to one aspect of the invention, a method of terrain mapping includes determining the position of an aircraft with respect to one or more elements of a digital terrain elevation data array, wherein each element of the digital terrain elevation data array is associated with a single latitude and a single longitude point of terrain to be overflown by the aircraft and scanned by a laser obstacle detector carried by the aircraft and arranged to provide height data and wherein each element of the digital terrain elevation data array includes height data for an associated point of terrain, arranging a laser obstacle detector co-ordinate frame, wherein each element of the laser obstacle detector co-ordinate frame stores height data received from the laser obstacle detector, determining the position of each element of the digital terrain elevation data array with respect to one or more elements of the laser obstacle detector co-ordinate frame, and determining updated height data for each digital terrain elevation data array element using the height data of a predetermined number of surrounding elements of the laser obstacle detector co-ordinate frame.

It will be understood that a single latitude and single longitude point is with reference to a geographic axis.

Preferably, the method may include arranging a digital elevation array wherein each element of the digital elevation array is associated with a single latitude and a single longitude point of the terrain to be overflown by the aircraft, arranging each element of the digital elevation array to store elevation data, including height data, and associating each element of the digital elevation array with a single element of the digital terrain elevation data array and storing the updated height data for each digital terrain elevation data array element in the associated element of the digital elevation array.

Each element of the digital terrain elevation data array includes estimated height error data and the method may also include determining updated estimated height error data for each digital terrain elevation data array element using estimated height error data of a predetermined number of surrounding elements of the laser obstacle detector co-ordinate frame. The method may include arranging the elevation data of each element of the digital elevation array to also store estimated height error data and storing the updated estimated height error for each digital terrain elevation data array element in the associated element of the digital elevation array.

Advantageously, the method may include determining the updated height data for each digital terrain elevation data array element using height data of the closest four elements of the laser obstacle detector co-ordinate frame. The method may include determining the updated height data for each digital terrain elevation data array element using bi-linear interpolation of the height data of the closest four elements of the laser obstacle detector co-ordinate frame.

The method may include determining the updated estimated height error for each digital terrain elevation data array element using estimated height error data of the closest four elements of the laser obstacle detector co-ordinate frame.

Preferably, the method may include determining the position of each element of the digital terrain elevation data array with respect to one or more elements of the laser obstacle detector co-ordinate frame using co-ordinate transformation geometry.

According to another aspect of the invention, a terrain mapping apparatus includes means arranged to determine the position of an aircraft with respect to one or more elements of a digital terrain elevation data array memory, wherein each element of the digital terrain elevation data array memory is associated with a single latitude and a single longitude point of terrain to be overflown by the aircraft and wherein each element of the digital terrain elevation data array memory is arranged to include height data for an associated point of terrain, a laser obstacle detector co-ordinate frame memory and an associated laser obstacle detector, wherein the laser obstacle detector is arranged to scan terrain to be overflown by the aircraft and generate height data and each element of the laser obstacle detector co-ordinate frame memory is arranged to store height data received from the laser obstacle detector, means arranged to determine the position of each element of the digital terrain elevation data array memory with respect to one or more elements of the laser obstacle detector co-ordinate frame memory, a mapping processor arranged to determine updated height data for each element of the digital terrain elevation data array memory from height data of a predetermined number of surrounding elements of the laser obstacle detector co-ordinate frame memory.

Preferably, the terrain mapping apparatus may include a digital elevation array memory, wherein each element of the digital elevation array memory is arranged to be associated with a single latitude and a single longitude point of the terrain to be overflown, each element of the digital elevation array memory being arranged to store elevation data, which includes height data, and means to associate each element of the digital elevation array memory with a single element of the digital terrain elevation data array memory and the digital elevation array memory being arranged to store the updated height data for each associated element of the digital terrain elevation data array memory.

The terrain mapping apparatus may be carried by an aircraft, for example a helicopter or an aeroplane.

The invention will now be described, by way of example only, with reference to the accompanying drawings, in which:

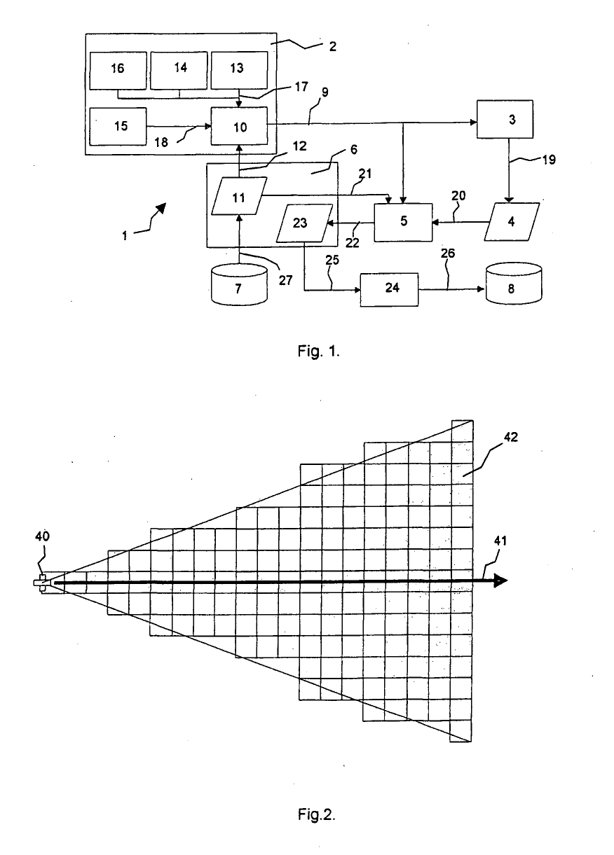

FIG. 1 is a schematic illustration of apparatus according to an embodiment of the present invention;

FIG. 2 illustrates an array of terrain heights returned by a laser obstacle detector;

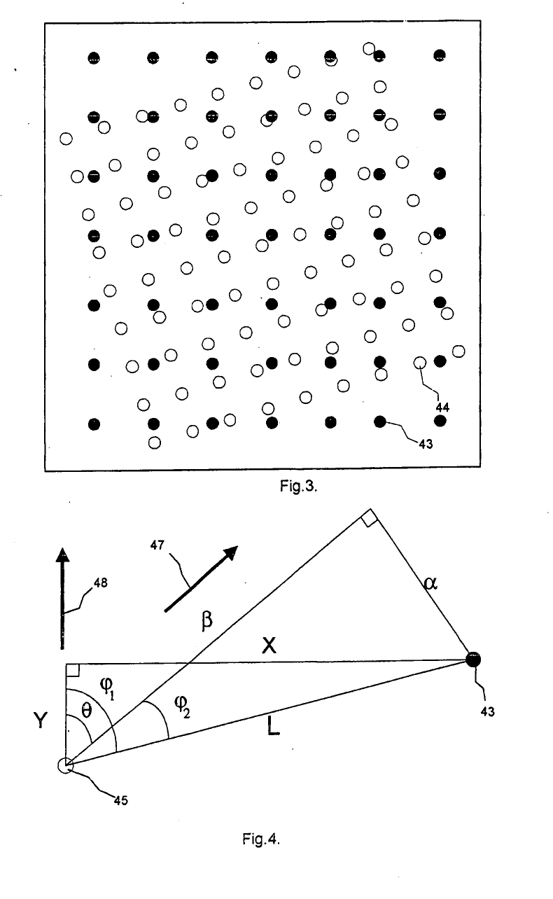

FIG. 3 illustrates superimposition of elements of a laser obstacle detector co-ordinate frame on elements of a digital terrain elevation data array;

FIG. 4 illustrates co-ordinate transformation geometry of the position of an aircraft with respect to an element of a digital terrain elevation data array; and

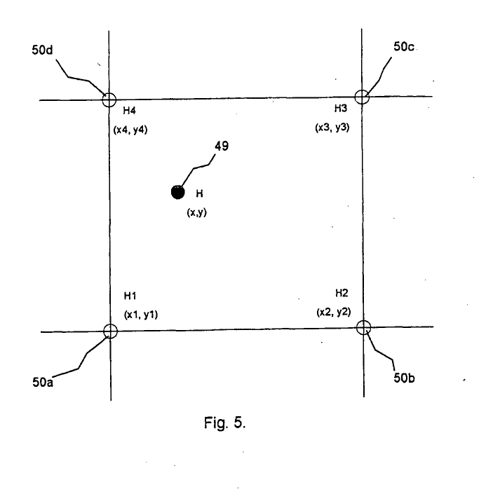

FIG. 5 illustrates the process of bi-linear interpolation to derive height data for an element of the digital terrain elevation data array from the closest elements identified in the laser obstacle detector co-ordinate frame.

The embodiment described herein produces digital elevation data in real time with accuracies and post spacing comparable with the proposed requirements of level 3 digital terrain elevation data (DTED), see Table 1, below. The process of this embodiment also provides the position, heights and locations of obstacles in an area surveyed measured with the same accuracy.

TABLE 1
Accuracy Requirements for Digital Terrain Elevation Data (DTED)

| | | | Absolute | Absolute |
|---|---|---|---|---|
| | | | Horizontal | Vertical |
| DTED | Element Spacing | | Error | Error |
| 1 | 3.0 sec | (approx. 100 m) | 50 m | 30 m |
| 2 | 1.0 sec | (approx. 30 m) | 23 m | 18 m |
| 3 | 0.3333 sec | (approx. 10 m) | 10 m | 10 m |
| | | | (proposed) | (proposed) |

Referring to FIG. 1, there is illustrated a block diagram of a terrain mapping apparatus 1 to be carried by an aircraft, which includes an integrated navigation system 2, a laser obstacle detector 3, a laser obstacle detector co-ordinate frame memory 4, a mapping processor 5, a working map memory 6, a digital terrain elevation data array memory 7 and a digital elevation array memory 8, inter-connected and arranged to function as described below.

The integrated array navigation system 2 is arranged to provide a terrain corrected position of the aircraft with respect to terrain to be overflown by the aircraft at an output 9 from the integrated navigation system 2. Accordingly, the integrated navigation system 2 includes a terrain referenced navigation system 10 which receives an input 11 of map data in the form of digital terrain elevation data from elements of the digital terrain elevation data array memory 7 via a file data storage area 12 of the working map memory 6. The terrain navigation referenced system 10 can also receive inputs from an inertial navigation system 13, a radar altimeter 14, a global positioning system 15 or other navigational sensor 16, via inputs 17 and/or 18.

The inertial navigation system 13 is arranged to provide accurate estimates of the position, velocity and acceleration of the aircraft carrying the terrain mapping processor 1. However, such equipment is known to suffer from a positional drift rate of approximately 1 nautical mile per hour. This positional drift can be corrected by the terrain navigational reference system 10 using information from the radar altimeter 14, data from the digital terrain elevation array memory 7 together with data from the global positioning system 15, if available, over input 18. However, it will be understood by those skilled in the art that correction using a global positioning system 14 is not essential to the present embodiment.

The terrain referenced navigation system 10 uses a combination of the digital terrain elevation data provided by elements of the digital terrain elevation data array memory 7 and the radar altimeter 14 to generate corrections to the latitude, longitude and height data provided by the inertial navigation system 12 on output 9, which accurately references the aircraft position relative the elements of the digital terrain elevation data array memory 7. The positional uncertainties of the aircraft relative to the elements of the digital terrain elevation data array memory 7 are typically less than 10 m horizontal and 5 m vertical. These uncertainties are comparable with the proposed requirements of DTED Level 3, shown in Table 1.

The terrain corrected position for the aircraft is provided at output 9 from the integrated navigation system 2 to both the mapping processor 5 and the laser obstacle detector 3. The terrain referenced navigation corrected position for the aircraft is used by the laser obstacle detector 3 to reference the position of the laser obstacle detector 3 with respect to the terrain overflown by the aircraft and terrain or obstacles detected by the laser obstacle detector 3. The position of the terrain and obstacles thus share the underlying accuracy of the integrated navigation system 2 as the errors due to the laser measurement system of the laser obstacle detector 3 are relatively low when compared to those produced by the integrated navigation system 2. The laser obstacle detector 3 produces positional and height data for detected terrain and/or obstacles which are passed to and stored in appropriate elements of the laser obstacle detector co-ordinate frame memory 4 via connection 19. The height data for terrain and/or obstacles can be returned as an array of elevation spot heights as schematically illustrated in FIG. 2, wherein an aircraft 40 flying along a flight-path 41 carrying a laser obstacle detector 3 scans an azimuth area indicated by cross hatched scanned area 42. In this example, the extent or distance of the scanned area 42 from the aircraft 40 is approximately 1.5 km.

In operation, the density of elevation spot height returned by the laser obstacle detector 3 needs to be higher than the density of elements required for calculation of height data for element of the digital elevation array 8. This is not an issue, as the laser obstacle detector 3 can determine elevation spot heights to centimetric accuracy; the limitation in a practical system being the bandwidth required for data transfer of height data from the laser obstacle detector 3 to its associated laser obstacle detector co-ordinate frame memory 4 or connection 19.

The laser obstacle detector co-ordinate frame memory 4 supplies an input 20 to mapping processor 5, which also receives the terrain corrected position for the aircraft provided at output 9 from the integrated navigation system 2. Furthermore, the mapping processor 5 also receives an input 21 of map data in the form of digital terrain elevation data from the elements of the digital terrain elevation data array memory 7 via the file data storage area 12 of the working map memory 6. The operation of the mapping processor 5 will be described in more detail below, but in summary the mapping processor 5 generates a refined map at output 22 which is then stored in a refined map memory 23 of the working map memory 6. The refined map can then be stored in the digital elevation array memory 8 via storage processor 24, which receives the refined map over output 25 from the refined map memory 23. The storage processor 24 is arranged to format the refined map in a manner suitable for storage in the elements of the digital elevation array memory 8 and outputs the formatted refined map data on output 26 to the digital elevation array memory 8 for storage.

Known map data stored in the digital terrain elevation data array memory 7 is provided to the file data storage area 12 of the working map memory 6 via output 27.

In operation, the mapping processor 5 is arranged to receive elements of the digital terrain elevation data array 7 via file data storage area 12 over input 21 and to determine those elements of the digital terrain elevation data array 7 which encompasses a sufficient terrain area surrounding the aircraft. At this stage, no assumption is made about the azimuth position of the aircraft. The mapping processor 5 determines an appropriate number of elements of the digital terrain elevation data array memory 7 surrounding the aircraft such that the aircraft is located within a central position to the in use elements of the digital terrain elevation data array memory 7. Normally, the height data stored within each element of the digital terrain elevation data array memory 7 has a specific value. However, in the absence of a specific value for height data of an element, a unique value indicating null height data, for example-999, is used to confirm an absence of height data. The South West corner of the selected elements of the digital terrain elevation data array memory 7 is then identified as the start position for processing of selected elements so that the processing of such elements and associated height data within the digital terrain elevation data array memory 7 by the mapping processor 5 is standardised. Referring to FIG. 3, those elements of the digital terrain elevation data array memory 7 identified by the mapping processor 5 are indicated by the dark spots 43.

Returning to FIG. 1, the mapping processor 5 receives height data associated with elements of the laser obstacle detector co-ordinate frame memory 4 over input 20 and converts the relative height data measured with respect to the aircraft altitude into absolute height data by addition of the aircraft altitude to the height data of each element of the laser obstacle detector co-ordinate frame memory 4. The mapping processor 5 then determines for each element of the digital terrain elevation data array 7 identified as being relevant to the aircraft position, the height determined for the nearest element or elements of the laser obstacle detector co-ordinate frame 4, adjusted for aircraft altitude. This can be more clearly observed in FIG. 3, wherein the elements of the laser obstacle detector co-ordinate frame memory 4 shown as light spots 44 have been overlaid on the dark spots 43 indicating the elements of the relevant digital terrain elevation data array memory 7.

As an overview of the process for determining the height data obtained for each element of laser obstacle detector co-ordinate frame memory 4 and hence updated height data for each selected element of the digital terrain elevation data array memory 7, the mapping processor 5 transforms the position of each identified element of the digital terrain elevation data array memory 7 into a position in the laser obstacle detector co-ordinate frame memory 4, determines the closest four elements of the laser obstacle detector co-ordinate frame memory 4 to each of the identified elements of digital terrain elevation data array memory 7 and then using interpolation, estimates the updated height data. It will be noted that any elements of data obstacle detector co-ordinate frame memory 4 having a null terrain height data is not included for processing by the mapping processor 5.

Referring to FIG. 4, the geometry of determining the position of an element of the digital terrain elevation data array memory 7 with respect to an element of the laser obstacle detector co-ordinate frame memory 4 is illustrated. The position of the aircraft is indicated by light spot 45 and the position of an element of the digital terrain elevation data array memory 7 is indicated by dark spot 46. The heading of the aircraft is indicated by arrow 47 and the heading is measured from true North indicated by arrow 48. That is, the heading of the aircraft is indicated by angle θ between the true North arrow 48 and the heading arrow 47.

Accordingly, the following identities can be determined for the aircraft:

$${X}^{2} + {Y}^{2} = {α}^{2} + {β}^{2} = {L}^{2}$$

$${φ}_{1} = {tan}^{- 1} ( \frac{x}{y} )$$

$${φ}_{2} = {tan}^{- 1} ( \frac{α}{β} )$$

$${φ}_{2} = {φ}_{1} - θ$$

$$α = L sin {φ}_{2}$$

$$β = L cos {φ}_{2}$$

The values for α and β are used to identify the position of an element of the digital terrain elevation data array memory 7, in the laser obstacle detector co-ordinate frame memory 4 and are stored with the height data in the digital terrain elevation data array memory 7.

Having established the position of each selected element of the digital terrain elevation data array memory 7 with respect to one or more elements within the laser obstacle detector co-ordinate frame memory 4, height data can be determined for each selected element of the digital terrain elevation data array memory 7 by a bi-linear interpolation of height data from four surrounding elements selected from the laser obstacle detector co-ordinate frame memory 4. The identity of the surrounding elements selected from the laser obstacle detector co-ordinate frame memory 4 can be established by “integerising” the co-ordinate of the selected element of the digital terrain elevation data array memory 7. Referring to FIG. 5, wherein an element of the digital terrain elevation data array memory 7 is indicated by dark spot 49 and surrounded by four elements 50a, 50b, 50c and 50d of the laser obstacle detector co-ordinate frame memory 4. From FIG. 5, the following definitions can be determined:

$$t = \frac{x - {x}_{4}}{{x}_{3} - {x}_{4}}$$

$$u = \frac{y - {y}_{4}}{{y}_{3} - {y}_{4}}$$

$$and$$

$${H}_{( x , y )} = ( 1 - t ) ( 1 - u ) {H}_{1} + t ( 1 - u ) {H}_{2} + {tuH}_{3} + ( 1 - t ) {uH}_{4} .$$

If any of the four surrounding elements of the laser obstacle detector co-ordinate frame memory 4 contain a null value or do not exist, the height data of the digital terrain elevation data array element remains unchanged from its initialised value indicating null height data to prevent erroneous information being incorporated in the eventual elevation data for each element of the digital elevation array memory 8.

The results of the bi-linear interpolation are returned to the refined map memory 23 over output 22 from the mapping processor 5. Each element of the digital elevation array memory 8 is associated with a single latitude and a single longitude point of terrain overflown by the aircraft and is associated with a single element of the digital terrain elevation data array memory 7. The digital elevation array memory 8 in this case is a two dimensional array which uses x and y spacing corresponding to the required spacing of elements of the digital terrain elevation data array memory 7 together with a defined start point. Each element of the digital elevation array memory 8 contains elevation data including current digital height data from the refined map 23, which is provided on output 25 to storage processor 24 for storage in the digital elevation array memory 8 over output 26.

For each element in the digital elevation array memory 8 the following elevation data can be maintained:
number of detections;
height—an average of all measurements;
estimated height error—based on the standard deviation of all measurements;
height sum; and
height sum of squares.

Accordingly, each selected element of the digital terrain elevation data array memory 7 is passed through the mapping processor 5 and for each selected element in the digital terrain elevation data array memory 7 the following processing is performed:
the position of the corresponding geographical element in the digital elevation array memory 8 is identified,
if there is valid height information for an element of digital elevation array memory 8 (i.e. the height data of the digital elevation array element is not indicated as null height data) then:
the number of detections is incremented;
the height is added to the height sum;
the square of the height is added to the height sum of squares;
the height information can be calculated using an averaging process and an estimated height error is estimated by calculating the standard deviation; and
the height information is then stored in the correct element of the digital elevation array memory 8.

This process is repeated for each selected element of the digital terrain elevation data array memory 7. During the course of a flight of the aircraft, each terrain point will probably be observed many times. Positional and height uncertainties in each measurement will be transformed into a height uncertainty in the final elevation data of the digital elevation array memory 8. This information is also used to perform statistical filtering of the input data, for example using three sigma rejection, to prevent erroneous or noisy data being incorporated into the determined elevation data.

At the conclusion of the mapping flight, the digital elevation array memory 8 and the digital terrain elevation data array memory 7 are written out for further processing and any measured map shift can be analysed. The digital elevation array memory 8 is converted into the format to be used for a future digital terrain elevation data array memory 7. This is facilitated by choosing an array spacing which corresponds to the spacing used by the digital terrain elevation data array memory 7.

The original digital terrain elevation data array memory 7 is retained as it gives an indication of errors in height points for individual elements, which can be read back into the system as the basis of further mapping flight of the area.

1. A method of terrain mapping, including:
determining the position of an aircraft with respect to one or more elements of a digital terrain elevation data array, wherein each element of the digital terrain elevation data array is associated with a single latitude and a single longitude point of terrain to be overflown by the aircraft and scanned by a laser obstacle detector carried by the aircraft and arranged to provide height data and wherein each element of the digital terrain elevation data array includes height data for an associated point of terrain;
arranging a laser obstacle detector co-ordinate frame, wherein each element of the laser obstacle detector co-ordinate frame stores height data received from the laser obstacle detector;
determining the position of each element of the digital terrain elevation data array with respect to one or more elements of the laser obstacle detector co-ordinate frame; and
determining updated height data for each digital terrain elevation data array element using the height data of a predetermined number of surrounding elements of the laser obstacle detector co-ordinate frame.

2. A method, as claimed in claim 1, including arranging a digital elevation array wherein each element of the digital elevation array is associated with a single latitude and a single longitude point of terrain to be overflown by the aircraft, arranging each element of the digital elevation array to store elevation data, including height data, and associating each element of the digital elevation array with a single element of the digital terrain elevation data array and storing the updated height data for each digital terrain elevation data array element in the associated element of the digital elevation array.

3. A method, as claimed in claim 1, wherein each element of the digital terrain elevation data array includes estimated height error data and the method includes determining updated estimated height error data for each digital terrain elevation data array element using estimated height error data of a predetermined number of surrounding elements of the laser obstacle detector co-ordinate frame.

4. A method, as claimed in claim 2, including arranging the elevation data of each element of the digital elevation array to also store estimated height error data and storing the updated estimated height error for each digital terrain elevation data array element in the associated element of the digital elevation array.

5. A method, as claimed in claim 1, including determining the updated height data for each digital terrain elevation data array element using height data of the closest four element of the laser obstacle detector co-ordinate frame.

6. A method, as claimed in claim 5, including determining the updated height data for each digital terrain elevation data array element using bi-linear interpolation of the height data of the closest four elements of the laser obstacle detector co-ordinate frame.

7. A method, as claimed in claim 3, including determining the updated estimated height error for each digital terrain elevation data array element using estimated height error data of the closest four elements of the laser obstacle detector co-ordinate frame.

8. A method, as claimed in claim 1, including determining the position of each element of the digital terrain elevation data array with respect to one or more elements of the laser obstacle detector co-ordinate frame using co-ordinate transformation geometry.

9. A terrain mapping apparatus, including:
means arranged to determine the position of an aircraft with respect to one or more elements of a digital terrain elevation data array memory, wherein each element of the digital terrain elevation data array memory is associated with a single latitude and a single longitude point of terrain to be overflown by the aircraft and wherein each element of the digital terrain elevation data array memory is arranged to include height data for an associated point of terrain;
a laser obstacle detector co-ordinate frame memory and an associated laser obstacle detector, wherein the laser obstacle detector is arranged to scan terrain to be overflown by the aircraft and generate height data and each element of the laser obstacle detector co-ordinate frame memory is arranged to store height data received from the laser obstacle detector;
means arranged to determine the position of each element of the digital terrain elevation data array memory with respect to one or more elements of the laser obstacle detector co-ordinate frame memory;
a mapping processor arranged to determine updated height data for each element of the digital terrain elevation data array memory from height data of a predetermined number of surrounding elements of the laser obstacle detector co-ordinate frame memory.

10. A terrain mapping apparatus, as claimed in claim 9, including a digital elevation array memory, wherein each element of the digital elevation array memory is arranged to be associated with a single latitude and a single longitude point of the terrain to be overflown, each element of the digital elevation array memory being arranged to store elevation data, which includes height data, and means to associate each element of the digital elevation array memory with a single element of the digital terrain elevation data array memory and the digital elevation array memory being arranged to store the updated height data for each associated element of the digital terrain elevation data array memory.

11. An aircraft arranged to carry a terrain mapping apparatus as claimed in claims 9.
